(19) United States
(12) Patent Application Publication
(10) Pub. No.: US 2026/0010661 A1
(43) Pub. Date: Jan. 8, 2026

(54) Applying Different Visual Transformations to Sensitive User Input Based on Input-Device Type

(71) Applicant: Google LLC, Mountain View, CA (US)

(72) Inventors: Christoph Michael Schlosser, Traunstein (DE); Serguei Kisliak, Ottobrunn (DE); Sean Michael Harrison, Munich (DE); Md Shahadat Hossain Shahin, Munich (DE)

(73) Assignee: Google LLC, Mountain View, CA (US)

(21) Appl. No.: 19/325,793

(22) Filed: Sep. 11, 2025

Related U.S. Application Data
(60) Provisional application No. 63/875,619, filed on Sep. 4, 2025.

(51) Int. Cl. G06F 21/84; G06F 3/04886; G06F 3/0489; G06T 11/00

(52) U.S. Cl. CPC G06F 21/84; G06F 3/04886; G06F 3/0489; G06T 11/00

(57) ABSTRACT

Systems and methods are disclosed herein for applying different visual transformations to sensitive user input based on input-device type. The described techniques distinguish between input sources and apply different, user-configurable, visual transformations based on the source of the input. In this way, user input from a hardware input device, which may provide tactile feedback, can be handled differently from input from a software input device, which may benefit from visual feedback. Such techniques can thereby improve security and usability when entering sensitive information, such as a password or an account number.

### CROSS-REFERENCE TO RELATED APPLICATION

This application claims the benefit of U.S. Provisional Patent Application Ser. No. 63/875,619 filed on Sep. 4, 2025, the disclosure of which is incorporated by reference herein in its entirety.

### SUMMARY

Systems and methods are disclosed herein for applying different visual transformations to sensitive user input based on input-device type. The described techniques distinguish between input sources and apply different, user-configurable, visual transformations based on the source of the input. In this way, user input from a hardware input device, which may provide tactile feedback, can be handled differently from input from a software input device, which may benefit from visual feedback. Such techniques can thereby improve security, privacy, and usability when entering sensitive information, such as a password or an account number.

An electronic device is disclosed that comprises a display device, a memory storing an operating system (OS), and one or more processors. The OS includes OS settings for configuring visual transformations of input entered into a sensitive-data field displayed via the display device. The one or more processors are configured to control the visual transformations. To do this, the processors receive a key event corresponding to text being entered in the sensitive-data field and determine whether a source of the key event is a hardware input device or a software input device coupled to the electronic device. Based on this determination, the processors apply one of a plurality of visual transformations defined in the OS settings to the text. The plurality of visual transformations includes a first visual transformation associated with the hardware input device and a second, different visual transformation associated with the software input device.

In some implementations, the first visual transformation associated with the hardware input device renders the entered text as hidden text, for example, by displaying an asterisk or dot character. In some implementations, the second visual transformation associated with the software input device renders the entered text as echoed text, for example, by briefly displaying the last entered character before concealing it. The hardware input device can be a physical keyboard, and the software input device can be a virtual keyboard. The OS settings for the plurality of visual transformations may be independently controllable by a user, allowing for customized handling of input from different device types. The electronic device may also include an application programming interface configured to query information associated with the key event and a corresponding setting value from the OS settings.

This summary is provided to introduce simplified concepts of applying different visual transformations to sensitive user input based on input-device type, which is further described below in the Detailed Description. This summary is not intended to identify essential features of the claimed subject matter, nor is it intended for use in determining the scope of the claimed subject matter.

### BRIEF DESCRIPTION OF DRAWINGS

The details of one or more aspects of applying different visual transformations to sensitive user input based on input-device type are described in this document with reference to the following drawings. The same numbers are used throughout the drawings to reference like features and components:

FIG. 1 illustrates an example environment of a system for applying different visual transformations to sensitive data based on input-device type;

FIG. 2 illustrates an example implementation of the electronic device of FIG. 1 in more detail;

FIG. 3 illustrates an example system for applying different visual transformations to sensitive data based on input-device type in accordance with one or more implementations;

FIG. 4 illustrates a sequence diagram illustrating an example process for applying visual transformations to sensitive data provided by a software input device;

FIG. 5 illustrates a sequence diagram illustrating an example process for applying visual transformations to sensitive data provided by a hardware input device; and

FIG. 6 depicts an example method for applying different visual transformations to sensitive data based on input-device type.

### DETAILED DESCRIPTION

### Overview

The present disclosure relates to systems and methods for managing the display of sensitive user input, such as passwords or personal identification numbers (PINs), on an electronic device. The techniques described distinguish between different types of input devices—specifically hardware-input devices and software-input devices—and apply distinct, user-configurable visual transformations to the entered text based on the detected source. For instance, input from a hardware device like a physical keyboard, which provides tactile feedback and reference positions (for user fingers), can be immediately concealed to enhance security. In contrast, input from a software device like a virtual on-screen keyboard can be briefly displayed or “echoed” to the user before being concealed, thereby improving usability where tactile feedback is absent. This context-aware approach improves both the security and the user experience when entering sensitive information, particularly on devices that support multiple input modalities.

These techniques address the limitations of a single, system-wide setting for handling sensitive input. In conventional computing environments, devices such as laptops running mobile-first operating systems often accommodate both physical and virtual keyboards. However, a one-size-fits-all approach to character echoing can be either a security risk (e.g., displaying password characters on a large screen when using a physical keyboard) or a usability hindrance (e.g., hiding characters immediately when typing on a small, error-prone virtual keyboard). Furthermore, the settings for handling sensitive input in conventional computing systems are not user configurable.

Accordingly, the system described herein introduces a control mechanism within the device's operating system (OS). This is achieved by first determining the input source of each input event (e.g., key event). Key events from a physical hardware device are typically associated with metadata, such as a unique device identifier (ID), whereas key events from a virtual software device may lack this ID or have a specific virtual identifier. By inspecting this metadata, the system's processing logic can reliably differentiate between the input sources.

Based on this determination, the logic then consults one of two separate and independently controllable settings within the OS: a first setting for hardware-input devices and a second setting for software-input devices. Finally, the system applies the visual transformation defined in the corresponding setting to the character entered in the sensitive-data field. This allows for tailored, context-appropriate behavior that enhances security for physical keyboards while preserving the usability benefits of character echoing for virtual keyboards.

While features and concepts of the described techniques for applying different visual transformations to sensitive user input based on input-device type can be implemented in any number of different environments, aspects are described in the context of the following examples.

### Example System and Devices

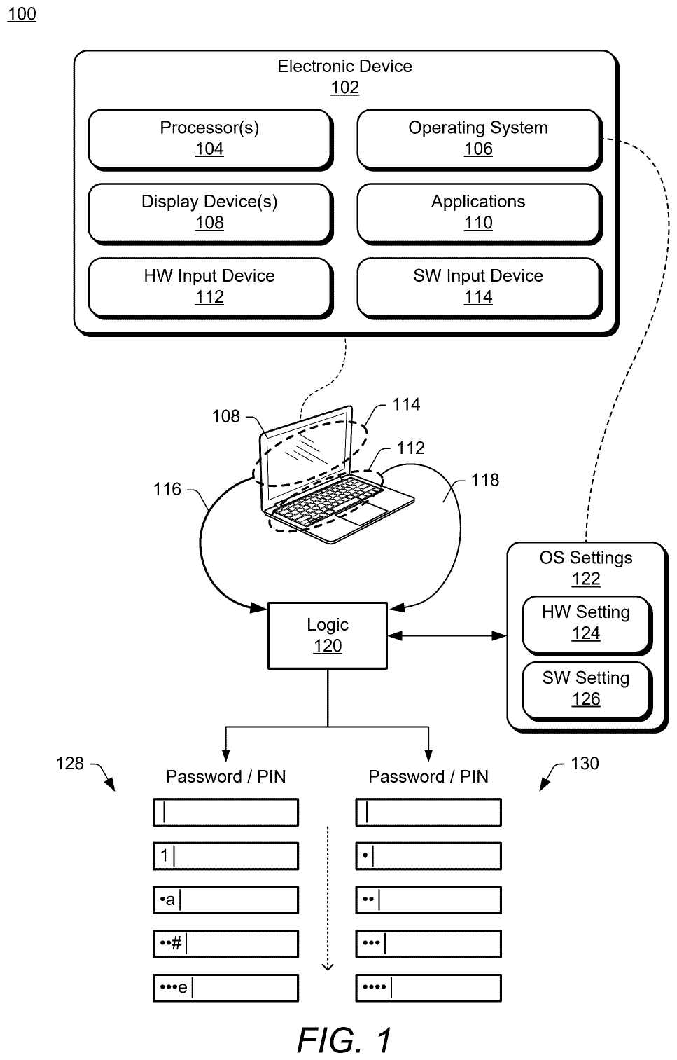

FIG. 1 illustrates an example implementation of a system 100 having an electronic device 102 including, but not limited to, one or more processors 104, an operating system (OS) 106, a display device 108, and one or more applications 110. The processor(s) 104 execute the operating system 106 and the applications 110 and cause information (e.g., media content) to be displayed via the display device 108. In aspects, the electronic device 102 includes at least one of a hardware (HW) input device 112 or a software (SW) input device 114.

The HW input device 112 can be any suitable hardware input device, such as a physical keyboard, a physical keypad, or other input device with mechanical buttons or actuators for providing user input. In some implementations, the HW input device 112 is separate from but communicatively coupled to the electronic device 102, such as via a wireless connection (e.g., Bluetooth™) or a wired connection (e.g., USB).

The SW input device 114 can be any suitable software input device, such as a virtual input device (e.g., virtual keyboard) that emulates the behavior of a hardware device. The SW input device 114 can be displayed via a display device 108 integrated with the electronic device 102 and/or can be displayed on a second display device that is communicatively coupled to but physically separate from the electronic device 102. For example, the electronic device 102 may be a mobile phone with a virtual keyboard rendered via the display screen of the mobile phone. In another example, the mobile phone can cast its screen to a second display device, such as a television or computer monitor, and the virtual keyboard or a data field (e.g., a sensitive data field) can be displayed on the second display device, with the touch input to the virtual keyboard being limited to the mobile phone itself.

The display device 108 can be a touch-sensitive display configured to receive and detect touch input by a user. The display device 108 can be used to render digital content including media content (e.g., images, video, text).

In implementations, the electronic device 102 receives a key event 116 from the SW input device 114 or a key event 118 from the HW input device 112. The key event 116, 118 may correspond to a user input being entered into a sensitive-input field (e.g., a “secret” field) used for sensitive data such as a password, a passcode, a lockscreen pin, a credit card number, an account number, etc. The key event 116, 118 is passed to logic 120 (e.g., processing logic) of the electronic device 102, and the logic 120 determines whether the key event originated from the SW input device 114 or the HW input device 112. Then, the logic 120 queries OS settings 122 of the operating system 106 to determine how to handle the key event 116, 118 for display.

The OS settings 122 include separate settings for key events originating from the HW input device 112 and key events originating from the SW input device 114. In particular, the display of key events for user input entered into a sensitive-data field is handled differently based on the type of input device used to generate the key events. For example, the OS settings 122 include a first setting (e.g., HW setting 124) for applying a visual transformation to input that originates from the HW input device 112, and a second setting (e.g., SW setting 126) for applying a second visual transformation to input that originates from the SW input device 114. The HW setting 124 and the SW setting 126 are independent, user-configurable settings, which can have default settings as described below. The electronic device 102 may also include an application programming interface (API) configured to query information associated with the key event, such as key-event information, and query a corresponding setting value from the OS settings 122.

In implementations, the SW setting 126 can define, by default, that the key events 116 received from the SW input device 114 are echoed (e.g., “echo”), such that the last character in a string is briefly displayed (e.g., for 1-5 seconds or until a next key event is received) to provide feedback corresponding to the virtual keyboard input. An example of echoed text is illustrated in the progression shown at 128 where the last character is shown and then hidden when a new character is entered.

In implementations, the HW setting 124 can define, by default, that the key events 118 received from the HW input device 112 are immediately hidden (e.g., “hide”). This is because the HW input device 112 (e.g., physical keyboard) provides tactile feedback to the user so visual feedback via the display device may not be necessary. An example of text entered into a sensitive-data field using the HW input device 112 is illustrated in the progression shown at 130 where each character, including the last character, is hidden immediately upon display.

In some implementations, HW setting 124 is automatically enabled/disabled based on whether the HW input device 112 is connected/disconnected to the electronic device 102, respectively. In another example, the SW setting 126 can be enabled/disabled based on an external SW input device 114 being connected/disconnected to/from the electronic device 102, respectively. Alternatively or additionally, the HW setting 124 can be enabled/disabled in response to a mode change of the electronic device 102, such as a “clamshell” device that is opened/closed to provide/remove access to its physical keyboard, respectively. In some examples, a clamshell device may, when closed or folded, enable a virtual keyboard via a back display (e.g., display on back of device that is usable in the closed orientation) and automatically enable the SW setting 126.

The logic 120 retrieves the specific setting that corresponds to the determined input source. Then, the appropriate visual transformation is applied to the text in the sensitive-data field, according to the specific setting. In some cases, the logic 120 retrieves the specific setting that is enabled, which may be based on, for example, whether the HW input device 112 is connected/disconnected to/from the electronic device 102 or based on the device mode of the electronic device 102.

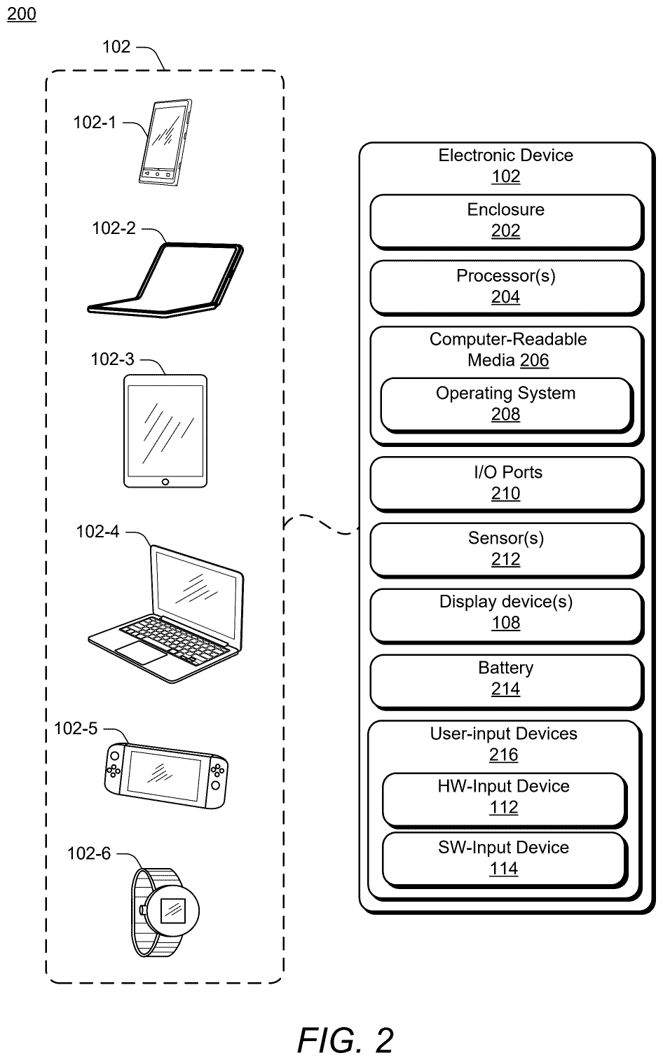

FIG. 2 illustrates an example implementation 200 of the electronic device 102 from FIG. 1. The electronic device 102 of FIG. 2 is illustrated with a variety of example devices, including a mobile phone 102-1, an electronic device 102-2, a tablet 102-3, a laptop 102-4, a video game console 102-5, and computing watch 102-6. The electronic device 102 can also include other devices, such as televisions, entertainment systems, audio systems, automobiles, drones, track pads, drawing pads, netbooks, e-readers, computing spectacles, home security systems, a home-automation and control system, a microwave, and other home appliances. Note that the electronic device 102 can be mobile, wearable, non-wearable but mobile, or relatively immobile (e.g., desktops and appliances). The electronic device 102 can include additional components and interfaces omitted from FIG. 2 for the sake of clarity.

The electronic device 102 includes an enclosure (e.g., enclosure 202), which houses various components that enable the electronic device 102 to function as a computing device. For example, the electronic device 102 can further include one or more processors 204. The processors(s) 204 can include, as non-limiting examples, a system on a chip (SoC), an application processor (AP), a central processing unit (CPU), or a graphics processing unit (GPU). The processors(s) 204 generally execute commands and processes utilized by the electronic device 102 and an operating system installed thereon. For example, the processors(s) 204 can perform operations to display graphics of the electronic device 102 on the one or more display devices 108 and can perform other specific computational tasks.

The electronic device 102 can also include computer-readable storage media (CRM) 206. The CRM 206 may be a suitable storage device configured to store device data of the electronic device 102, user data, and multimedia data. The CRM 206 can store an operating system 208 that generally manages hardware and software resources (e.g., the applications) of the electronic device 102 and provides common services for applications stored on the CRM 206. The operating system 208 and the applications are generally executable by the processors(s) 204 to enable communications and user interaction with the electronic device 102. One or more processors(s) 204, such as a GPU, perform operations to display graphics of the electronic device 102 on the one or more display devices 108 and can perform other specific computational tasks. The processors(s) 204 can be single-core or multiple-core processors.

The electronic device 102 can also include input/output (I/O) ports 210. The I/O ports 210 allow the electronic device 102 to interact with other devices or users. The I/O ports 210 may include any combination of internal or external ports, such as universal serial bus (USB) ports, audio ports, Serial Advanced Technology Attachment (SATA) ports, peripheral component interconnect express (PCI-express) based ports or card-slots, secure digital input/output (SDIO) slots, and/or other legacy ports.

The electronic device 102 can further include one or more sensors 212. The sensor(s) 212 can include any of a variety of sensors, such as an audio sensor (e.g., a microphone), a touch-input sensor (e.g., a touchscreen), an image-capture device (e.g., a camera, video-camera), proximity sensors (e.g., capacitive sensors), an under-display fingerprint sensor, or an ambient light sensor (e.g., photodetector). In implementations, the electronic device 102 can include one or more front-facing sensors and/or one or more rear-facing sensors.

Further, the electronic device 102 includes the one or more display devices 108. The display devices 108 can be any suitable display, including a touch-sensitive display device (e.g., a touchscreen, a liquid crystal display (LCD), a thin film transistor (TFT) LCD, an in-place switching (IPS) LCD, a capacitive touchscreen display, an organic light-emitting diode (OLED) display, an active-matrix organic light-emitting diode (AMOLED) display, a super AMOLED display, and so forth). The display device 108 may be referred to as a display or a screen, such that digital content may be displayed on-screen.

The electronic device 102 can further include a battery 214. In implementations, the battery 214 is a rechargeable battery that is configured to store and supply electrical energy. The rechargeable battery may be any suitable rechargeable battery, such as a lithium-ion (Li-ion) battery.

The electronic device 102 further includes one or more user-input devices 216, which may include the HW input device 112 and/or the SW input device 114. As mentioned, the electronic device 102 can include wireless communication technology to wirelessly couple to the HW input device 112 and/or the SW input device 114.

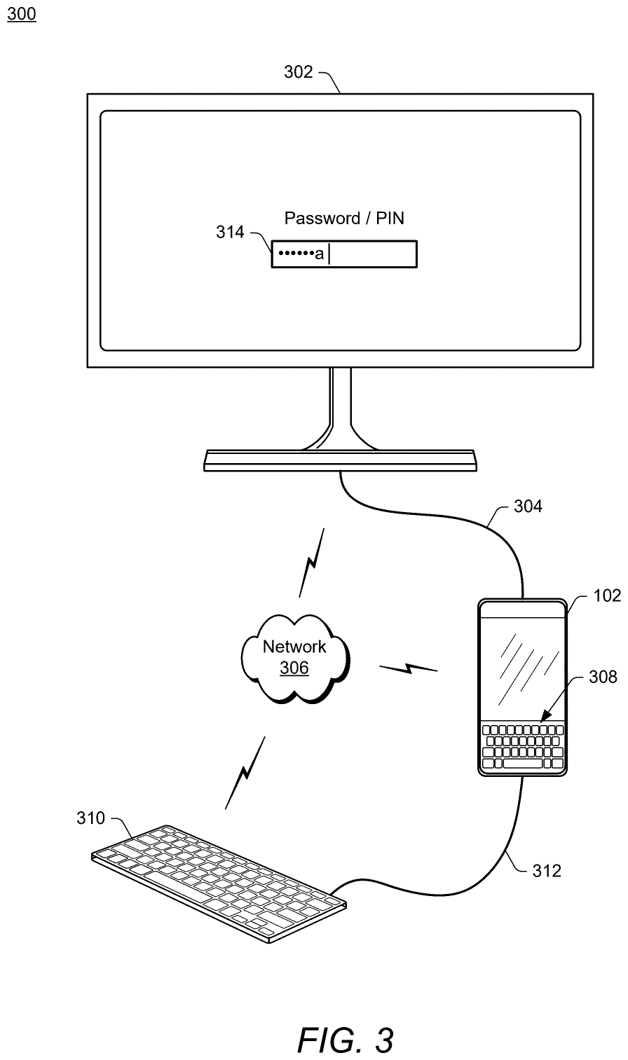

FIG. 3 illustrates an example implementation of a system for applying different visual transformations to sensitive data based on input-device type in accordance with one or more implementations. The electronic device 102 (e.g., mobile phone) is communicatively coupled to a large display 302, such as via a wired connection (e.g., cable 304) or a wireless connection (e.g., network 306). The electronic device 102 includes a virtual keyboard 308 (e.g., SW input device 114). In some cases, the electronic device 102 is also communicatively coupled to a physical keyboard 310 (e.g., HW input device 112) via a wired connection (e.g., cable 312) or a wireless connection (e.g., network 306).

The large display 302 is controlled by the electronic device 102 via the communicative coupling. Due to its size, the large display 302 may be viewable by any number of non-users (or non-authorized users) of the electronic device 102 who should not have visible access to sensitive information entered by the user of the electronic device 102. In this example, the user is entering a password into a sensitive-data field 314 (e.g., a secret field). If the user uses the physical keyboard 310 to enter the password, the electronic device 102 receives the user input, determines that the user input originates from the physical keyboard 310, and then determines to immediately hide the characters to be displayed in the sensitive-data field 314 based on a setting in the OS settings 122.

However, if the user enters the password via the virtual keyboard 308, the electronic device 102 receives the user input, determines that the user input originates from the virtual keyboard 308, and then determines to echo the characters (e.g., display the last character in the string) to be displayed in the sensitive-data field 314 based on a setting in the OS settings 122.

Because the electronic device 102 includes separate OS settings to determine which visual transformation to apply to the text in the sensitive-data field 314 based on the type of input source (e.g., physical or virtual), a first portion of the password can be provided via one input device and a second portion of the password can be provided via another input device. For example, the electronic device 102 can receive one or more key events from the physical keyboard 310 and one or more key events from the virtual keyboard 308, in any suitable order (in succession, interleaved, etc.). The electronic device 102 adjusts the visual transformation for each key event based on the input source. The electronic device 102 can provide hidden text in the sensitive-data field 314 for characters received from the physical keyboard 310 and can provide echoed text in the sensitive-data field 314 for characters received from the virtual keyboard 308.

These visual transformations may be applied based on default settings in the OS settings 122. In implementations, the user can configure the OS settings to “hide,” “echo,” or disable the hide/echo toggle that is dependent on the input source. In an example, the user can change the default OS settings to echo for HW input devices, hide for SW input devices, echo for both HW and SW input devices, or hide for both HW and SW input devices.

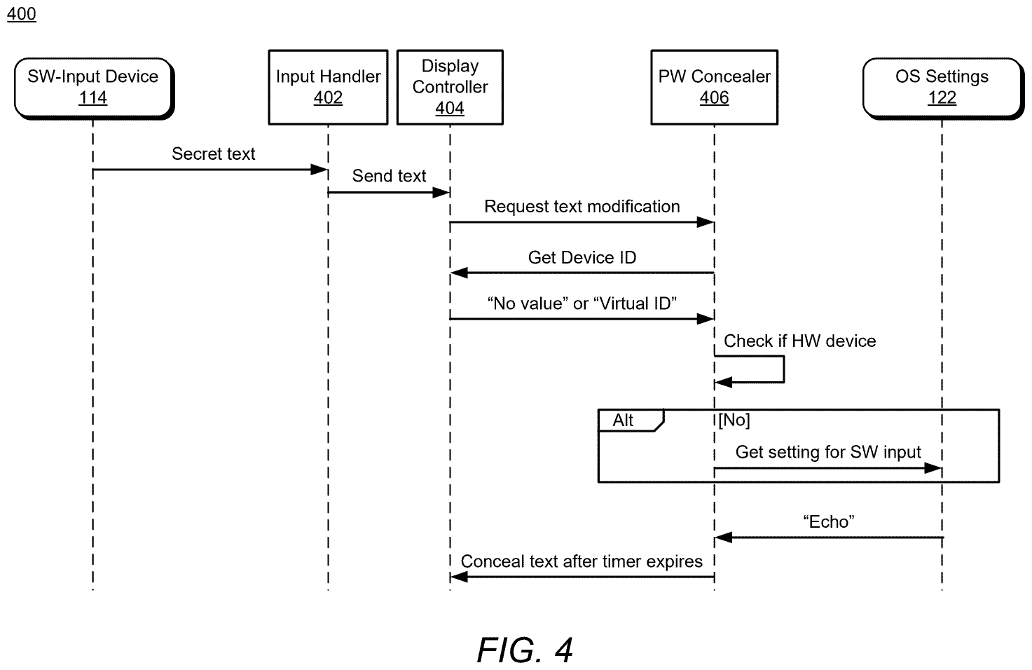

FIG. 4 illustrates a sequence diagram 400 illustrating an example process for applying visual transformations to sensitive data provided by a software input device. The SW input device 114 receives a user input that causes the SW input device 114 to generate a key event for entering text into a sensitive-data field. The text (e.g., secret text) is sent to an input handler 402, which manages and processes the text. In some examples, the input handler 402 is an API. In some implementations, the SW input device 114, such as a virtual keyboard, receives a touch input, processes the touch input, including its touch location and corresponding text or character, and then sends the text or character to the input handler 402. In one example, the SW input device 114 is a key-based virtual keyboard that sends a keystroke with a corresponding identifier. The input handler 402 sends the text to a display controller 404 configured to control a display of the text on a display device (e.g., the display device 108). Because the text is being entered into a sensitive-data field, the display controller 404 sends a request for text modification to a password (PW) concealer 406. The PW concealer 406 is configured to utilize a class or helper function to conceal (hide or echo) the text in the sensitive-data field. The PW concealer 406 returns a request for a device identifier (ID) of the input source to the display controller 404. For example, the request can include a “Get Device ID” request.

In response to the device ID request, the display controller 404 obtains a device ID from metadata associated with the text and provides the device ID to the PW concealer 406. The device ID may be a virtual ID value or may lack a value (e.g., blank value, absent value, “no value”), either of which can identify the input source as a software or virtual device. The PW concealer 406 then uses the device ID to determine if the input source is a hardware device or a software device. In some instances, the presence or absence of a physical device ID enables the processor to reliably distinguish between the HW and SW input sources. In some implementations, display controller 404 includes the device ID with the request for text modification, which reduces the latency of communication between the display controller 404 and the PW concealer 406 by reducing the number of communications. In this way, the “Get Device ID” request is not used.

In this case, the PW concealer 406 determines that the device ID belongs to a SW device (e.g., the SW input device 114). In response to determining that the input source is a SW device, the PW concealer queries the OS settings 122 to determine which visual transformation to apply to the text for a SW input device (e.g., “Get setting for SW input”). In this example, the OS settings 122 define the visual transformation for the SW input device 114 as an “echo.”

In response to receiving the echo setting, the PW concealer 406 sends an instruction to conceal the text after a timer expires (or after a next key event is received for the sensitive-data field). The display controller 404 then applies the visual transformation according to the setting. The input handler 402, the display controller 404, and the PW concealer 406 are components/modules included in the logic 120 in FIG. 1 and can be executed by the processor(s) 104.

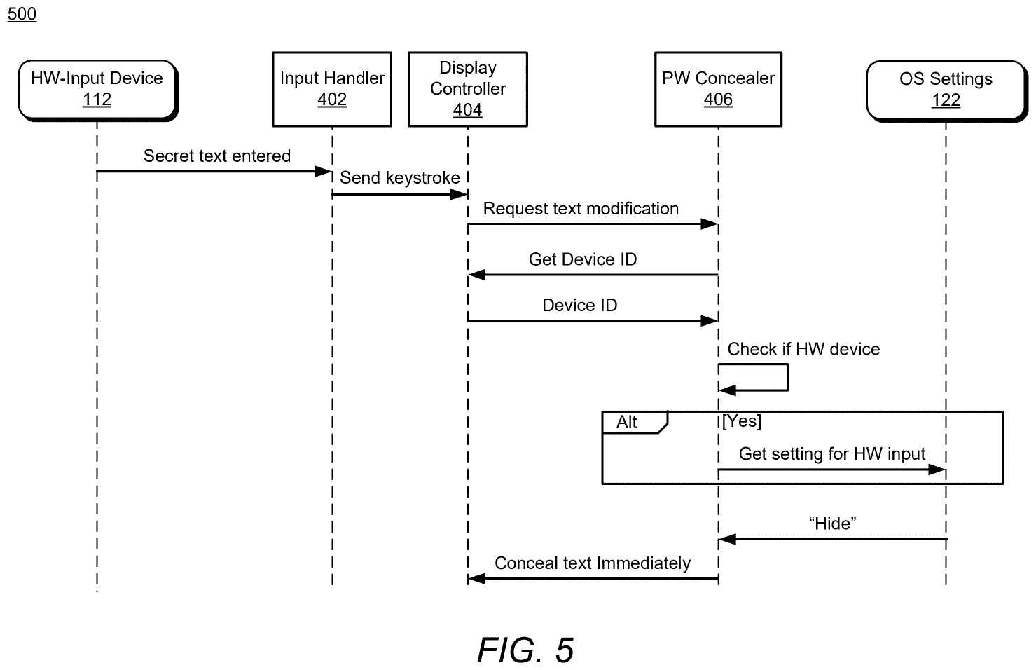

FIG. 5 illustrates a sequence diagram 500 illustrating an example process for applying visual transformations to sensitive data provided by a hardware input device. In this example, HW input device 112 receives a user input that causes the HW input device 112 to generate a key event (e.g., keystroke signal) for entering secret text into a sensitive-data field. The input handler 402, which manages and processes the secret text, receives the keystroke signal. The input handler 402 sends the keystroke signal to the display controller 404. Because the text is being entered into a sensitive-data field, the display controller 404 sends a request for text modification to the password (PW) concealer 406. The PW concealer 408 returns a request for a device identifier (ID) of the input source. In an example the request includes a “Get Device ID” request sent to the display controller 404.

In response to the device ID request, the display controller 404 obtains a device ID from metadata associated with the keystroke and provides the device ID to the PW concealer 406. The device ID includes a physical device ID, which identifies the input source of the keystroke as a hardware device (e.g., the HW input device 112). Using the device ID, the PW concealer 406 determines that the device ID belongs to a HW device (e.g., the HW input device 112).

In response to determining that the input source is a HW input device, the PW concealer queries the OS settings 122 to determine which visual transformation to apply to the secret text for a HW input device (e.g., “Get setting for HW input”). In this example, the OS settings 122 define the visual transformation for the HW input device 112 as “hide.” In response to receiving the hide setting, the PW concealer 406 sends an instruction to conceal the text immediately, such as by displaying a hidden character (e.g., bullet, asterisk, or other symbol) without displaying the text character associated with the keystroke. The display controller 404 then applies the visual transformation according to the setting.

The logical flow described herein (e.g., FIGS. 1, 4, and 5) can be integrated into the operating system's 106 framework and exposed to developers through an API and a software development kit (SDK). Such integration enables any application with a sensitive-data field to leverage the context-aware behavior described herein without requiring implementation of detection and transformation logic itself.

### Example Methods

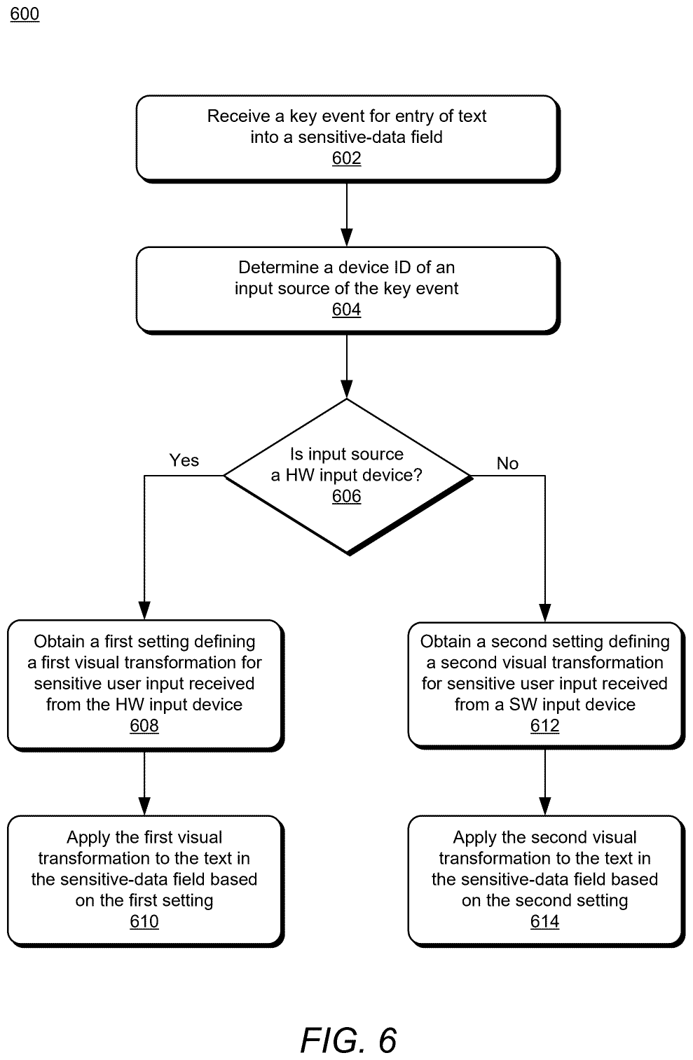

FIG. 6 depicts an example method 600 for applying different visual transformations to sensitive user input based on input-device type. The method 600 is shown as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. In portions of the following discussion, reference may be made to the example system 100 of FIG. 1 or to entities or processes as detailed in other figures, reference to which is made for example only. The techniques are not limited to performance by one entity or multiple entities operating on one device.

At 602, a key event is received for entry of text into a sensitive-data field. In an example, the key event is a keystroke (corresponding to the text) from the HW input device 112, such as a physical keyboard. In another example, the key event is the text (or a keystroke) from the SW input device 114, such as a virtual keyboard. The key event can be received by the input handler 402 of the electronic device 102.

At 604, a device ID of an input source of the key event is determined. For example, the device ID can be obtained from metadata associated with the key event. The device ID can include a value identifying whether the input device is a HW device or a SW device. As described above, the display controller 404 can obtain the device ID from the metadata in response to a request from the PW concealer 406.

At 606, a determination is made, based on the device ID, whether the input source of the key event is a HW input device (or a SW input device). The device ID can include a first value corresponding to a HW device (as described with respect to FIG. 5) or a second value (or no value) corresponding to a SW device (as described with respect to FIG. 4).

If the input source is a HW input device, then at 608, a first setting defining a first visual transformation for sensitive user input received from the HW input device is obtained from OS settings. As described above, the OS settings 122 include separate, individual settings for different input device types, including hardware or software devices. In an example, the PW concealer 406 queries the OS settings 122 for the HW setting 124, which corresponds to the HW input device 112.

At 610, the first visual transformation is applied to the text in the sensitive-data field based on the first setting. In an example, the text is hidden immediately responsive to the HW setting 124 including a “hide” value. The HW setting 124 defines the first visual transformation according to the input device type being a HW device, such as a physical keyboard.

If at 606 the input device is determined to not be a HW input device, which indicates that the input device is a SW input device, then at 612, a second setting defining a second visual transformation for the sensitive user input received from the SW input device is obtained from the OS settings. In an example, the PW concealer 406 queries the OS settings 122 for the SW setting 126, which corresponds to the SW input device 114.

At 614, the second visual transformation is applied to the text in the sensitive-data field based on the second setting. For example, the text is echoed responsive to the SW setting 126 including an “echo” value. The SW setting 126 defines the second visual transformation according to the input device type being a SW device, such as a virtual keyboard.

### Conclusion

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

Although implementations for applying different visual transformations to sensitive user input based on input-device type have been described in language specific to certain features and/or methods, the subject of the appended claims is not necessarily limited to the specific features or methods described. Rather, the specific features and methods are disclosed as example implementations for applying different visual transformations to sensitive user input based on input-device type, and other equivalent features and methods are intended to be within the scope of the appended claims. Further, various different aspects are described, and it is to be appreciated that each described aspect can be implemented independently or in connection with one or more other described aspects.

1. An electronic device comprising:
a display device;
a memory storing an operating system (OS) having OS settings for configuring visual transformations of input entered into a sensitive-data field displayed via the display device;
one or more processors configured to execute instructions stored in the memory to control the visual transformations, the one or more processors configured to:
receive a key event corresponding to text being entered in the sensitive-data field;
determine whether a source of the key event is a hardware input device coupled to the electronic device or a software input device coupled to the electronic device; and
apply one of a plurality of visual transformations defined in the OS settings to the text entered in the sensitive-data field based on whether the source of the key event is the hardware input device or the software input device, the plurality of visual transformations including a first visual transformation associated with the hardware input device and a second visual transformation associated with the software input device, the second visual transformation being different from the first visual transformation.

2. The electronic device of claim 1, wherein:
the first visual transformation associated with the hardware input device includes hidden text; and
the second visual transformation associated with the software input device includes echoed text.

3. The electronic device of claim 1, wherein the OS settings for configuring visual transformations are independently controllable.

4. The electronic device of claim 1, further comprising an application programming interface configured to query key-event information associated with the key event and a setting value from the OS settings corresponding to the hardware input device or the software input device.

5. The electronic device of claim 1, wherein the hardware input device comprises a physical keyboard, and the software input device comprises a virtual keyboard.

6. The electronic device of claim 1, wherein the key event is a keystroke from a physical keyboard.

7. The electronic device of claim 1, wherein the key event is text from a virtual keyboard.

8. The electronic device of claim 1, wherein the key event includes a device ID indicating the hardware input device or the software input device.

9. The electronic device of claim 1, wherein the key event is received via an input handler.

10. The electronic device of claim 1, wherein rendering the text character as echoed text comprises displaying the text character for a predetermined duration before replacing the text character with a concealing character.

11. The electronic device of claim 10, wherein the predetermined duration expires upon receipt of a subsequent key event.
